(19) United States
(12) Patent Application Publication
(10) Pub. No.: US 2025/0262466 A1
(43) Pub. Date: Aug. 21, 2025

(54) SELF-CONTAINED FIRE-EXTINGUISHING DEVICE FOR ELECTRICAL DEVICES

(71) Applicant: Yuriy Alexandrovich Gabliya, Moscow (RU)

(72) Inventor: Evgenii Sergeevich KAPLUN, Malaya Tsarevshchina (RU)

(21) Appl. No.: 18/862,938

(22) PCT Filed: Jul. 27, 2023
(86) PCT No.: PCT/RU2023/000230

§ 371 Date: Nov. 4, 2024

(30) Foreign Application Priority Data
Jul. 28, 2022 (RU) 2022120759

(51) Int. Cl. A62C 3/16; A62C 37/11; A62C 37/48; A62C 99/00

(52) U.S. Cl. CPC A62C 3/16; A62C 37/11; A62C 37/48; A62C 99/0018

(57) ABSTRACT

The invention relates to the field of fire-extinguishing, and more particularly to a fire-extinguishing device containing an aerosol-forming or gas-forming composition and comprising a housing (1), a module containing an aerosol-forming or gas-forming composition (2), and a trigger assembly in the form of a thermochemical igniter (15) containing a heat-sensitive element (16) and an electrical igniter of the aerosol-forming or gas-forming composition (6) which is triggerable by an external signal, the fire-extinguishing device further comprising at least one thermal fuse (3) installed in a power wire (11), wherein one of the contacts of said thermal fuse (3) is connected to a heat-sensitive trigger device (7) which is connected to the electrical igniter of the aerosol-forming or gas-forming composition (6). The technical result of the invention is a self-contained fire-extinguishing device which can be used for electrical sockets, socket boxes, electronic components, digital modules, printed circuit boards and electronic and electrical devices, and which can be triggered by a thermochemical igniter, an external electrical signal, or an internal or external heat-sensitive trigger device, the fire-extinguishing device also being capable of generating an information signal regarding the activation thereof.

### FIELD OF INVENTION

The invention relates to autonomous fire extinguishing plants based on aerosol-forming or gas-forming compositions and can be used to prevent fire in electrical outlets, outlet extensions and sub-outlets, computers, radio electronic equipment (REA), elements of digital and analog modules, electronic boards.

When operating electrical equipment, fire often occurs which causes are as follows: overload of electrical equipment and wiring, short circuit, ignition of flammable materials near connected equipment, excessive transient resistance in the contact groups of electrical wiring or printed circuit boards.

It is necessary to duly and automatically suppress the fire at the incipient stage with the possibility of voltage removal from the protected device (protected devices), and the formation of an information signal about the operation of the fire-extinguishing device automatically, without human intervention, eliminating the possibility of electric shock and saving expensive equipment, protecting the elements of automation and REA.

### STATE OF ART

The fire-extinguishing means that are known from the background of invention and designed to suppress fire in electrical installations are presented below.

An autonomous fire-extinguishing plant based on a thermally activated agent contained in microcapsules (patent RU 179466), comprising a polymer composite plate having a regular surface relief and containing microcapsules with a fire-extinguishing agent placed in a special organosilicon compound. The substrate of the plate on the reverse side bas a heat-resistant self-adhesive layer for its fastening in the protected volume. Microcapsules of 50-400 microns are used as a fire-extinguishing agent, having a core of a fire-extinguishing ozone-safe liquid placed inside a spherical polymer shell (patent RU 2469761). Microcapsules are capable of explosive destruction when the temperature reaches 90° C. This fire-extinguishing system is characterized by a low extinguishing capacity and a short service life (as the application practice shows, it is no more than two years), which is a significant disadvantage.

An autonomous gas fire-extinguishing plant (patent RU 139678) which comprises a cylinder with a gas-extinguishing agent (for example, halon), communicating with a main for supplying a fire-extinguishing medium to a protected volume designed using a fusible polymer material. The main is connected to the cylinder by means of a shut-off and starting device with a pressure gauge and a ball valve, and is also equipped with an elastic outer shell in the form of a metal spiral. This fire-extinguishing plant is characterized by multicomponence and high complexity of installation in a protected volume.

A mean of fastening a fire-extinguishing wire in an electric cabinet is known (patent RU 190409). A fire-extinguishing wire or pyrowire is an autonomous fire-extinguishing plant with a thermally activated microcapsulated fire-extinguishing agent designed to provide protection against fires in large-sized fire-hazardous facilities with electrical equipment such as switchboards, control cabinets, electrical cabinets, safes, etc. The technique according to this patent is a device holding a fire-extinguishing wire in an electric cabinet, having a support for fastening to the inner walls of the electric cabinet and designed in the form of a bending mount having a slot for holding the wire, and the base of the mount has an adhesive layer. The disadvantage of this technique is the complexity of a fire-extinguishing wire installation, associated with the need to install the claimed mean of fastening to the inner walls of the electrical cabinet along its perimeter, after which the fire-extinguishing wire is fastened in the mount.

A self-working fire-extinguishing device is known (patent RU 184841) which contains a foam housing comprising an explosive device and a fire-extinguishing agent. The explosive device is connected to a fire-conducting wire extending outward through the housing hole, and laid in a closed recess designed from the outside of the housing along its perimeter, and the width of the recess exceeds the width of the fire-conducting wire. To facilitate the rupture of the housing when an explosive device is triggered, grooves are designed on the inside of the housing. This device is suspended from a bracket or placed on a flat surface and independently activates when the flame contacts the fire-conducting wire. The disadvantage of this technique is that the fire-extinguishing device is placed in a guarded room with electrical equipment using a bracket or installed on a flat surface limiting its location options and reduces the effectiveness of fire extinguishing.

An automatic fire-extinguishing device for telecommunication equipment is known which is placed in a standard closed-type telecommunications rack (TCR) (patent RU 190222). The device is a single structure containing a housing comprising a flame-extinguishing agent generator (FEAG); the flame-extinguishing agent generator consists of two containers that are connected to a flame-extinguishing agent delivery system to the ignition source, consisting of pipelines and FEAG nozzles. The device triggering unit is designed in the form of an external linearly extended sensor, which is routed through the most heat-loaded areas of the TCR and connected to the input of the device, which, in turn, is connected inside the device to a sensor exceeding the temperature threshold. Additionally, this device comprises an alarm device (a light and sound indicator) indicating the fact that the generator has produced a flame-extinguishing agent. In this automatic fire-extinguishing device, standard flame-extinguishing agents are offered for use; they are characterized by insufficient extinguishing capacity and are unsafe in their chemical composition. It reduces the effectiveness of extinguishing, and the presence of pipelines and nozzles for supplying a flame-extinguishing agent to a guarded room increases the complexity of manufacturing the device, as well as installing the device in other types of rooms with electrical equipment is characterized by increased complexity of manufacturing in due to the use of standard methods of fastening to the TCR.

An autonomous fire-extinguishing device with a fastening on a DIN rail is known (patent RU 204767) comprising a housing that has a fire-extinguishing aerosol generator (FAG) with a triggering unit is located; FAG is constructed in the form of a housing designed using a non-flammable material with an outlet nozzle into which an aerosol-forming or gas-forming composition (AFC) is placed, and the housing of automatic firefighting system comprises nozzle openings for the output of an aerosol-forming or gas-forming composition and a slot for attaching the housing from FAG to a DIN rail, and the triggering unit comprises the form of a self-igniting thermal wire. Preferably, the triggering unit comprises the form of a self-igniting thermal wire with a heat-sensitive element; the activation temperature is less than the activation temperature of the thermal wire. The disadvantage of this device is that the applicable heat-sensitive element has high actuation temperatures, namely, it is known that such heat-sensitive elements are triggered at a temperature of at least 150° C.-180° C. allowing not to provide a rapid response to an increase in temperature during ignition and greatly delays the start of the extinguishing cycle. The absence of an eclectic igniter does not allow the device to be triggered by an external signal. In addition, there are no thermal fuses in the device not allowing to disconnect the load from the supply voltage in the event of a fire in the protected device. It should be noted that the device claimed in the patent does not comprise a triggering sensor and is not capable of issuing a signal at the beginning of the extinguishing process. Also, the device claimed in the patent is designed to be mounted only on a DIN rail and based on its size, it cannot be mounted in small volumes, for example, sub-outlets, power supplies, REA elements or computers.

This technique is the closest analogous solution to the claimed utility model and can act as a prototype.

### DISCLOSURE OF INVENTION

The technical issue that the claimed solution is aimed at solving is the expansion of the functionality of an autonomous fire-extinguishing device.

The technical result of the claimed invention is to provide the possibility of using an autonomous fire-extinguishing device for any electrical and electronic devices, as well as the possibility of initialization with a heat-chemical igniter, an external electrical signal or triggering from an internal or external heat-sensitive device, as well as capable of generating an information signal of the device triggering.

The achievement of the claimed technical result is carried out due to an autonomous fire-extinguishing device (AFED). The device comprises a housing made with the possibility of connecting conductors, inside which an aerosol-forming or gas-forming composition (AFC module) with triggering units is placed, the AFC module is placed in a housing with outlet nozzles, and comprises aerosol-forming or gas-forming compositions (AFC), and the triggering unit is made in the form of a heat-chemical igniter comprising a heat-sensitive element, and an electric igniter with the possibility of triggering an electric voltage through a triggering heat-sensitive device, to which a triggering voltage is applied through conductors or terminals, an electric igniter, in addition, there is an AFC trigger sensor in the housing to generate and output a signal to external devices about the fact of starting the fire-extinguishing process.

Alternatively, the AFED comprises thermal fuses that turn off the load power.

Alternatively, the AFED is attached to printed circuit boards using soldered pins.

Alternatively, the AFED is attached to printed circuit boards using contact soldered pads.

Alternatively, the AFED housing may be the housing of the sub-outlet.

Alternatively, the AFED housing can be directly the housing of the outlet with an internal or overhead embodiment of the latter.

Preferably, the triggering unit is made in the form of a heat-chemical igniter with a heat-sensitive chemical element, the triggering temperature of which is less than the triggering temperature of the heat-chemical igniter and the electric igniter of the AFC, which in turn is connected to a triggering heat-sensitive device and a conductor; the voltage is applied and an electric igniter can be triggered.

The claimed fire-extinguishing device is an assembly unit made in a single housing, and has a functional and constructive unity, therefore it can be claimed as a patent.

The possibility of mounting the claimed fire-extinguishing device, including an AFC module with a solid-fuel aerosol-forming or gas-forming composition, inside limited volumes with electrical or electronic equipment allows suppressing fire at installation sites with high extinguishing efficiency.

Taking into account that the aerosol-forming composition, in comparison with powder, carbon dioxide and foam compositions, has no restrictions on use (in terms of the power of the protected electrical equipment and the presence of voltage) and does not adversely affect electrical equipment or electronic equipment, the claimed fire-extinguishing device can be installed anywhere in the protected devices.

The presence of a triggering unit, in the form of a heat-chemical igniter and an electric AFC igniter, which is triggered using a triggering heat-sensitive device, as well as using an external signal, makes it possible to trigger the device at lower operating temperatures, for example 75° C. giving greater versatility and allowing the use the AFED as an element that expands the possibilities of extinguishing electrical

devices by combining several similar devices. When any of the device groups is triggered, all devices are triggered simultaneously.

The use of an AFED housing with a solid-fuel aerosol-forming or gas-forming composition makes it possible to mount or install an AFED without special fastening in any types of sub-outlets, outlets or outlet extensions, power supplies, REA housings, digital or electronic modules, on printed circuit boards and reduces the complexity in the manufacture of the device.

The aerosol-forming or gas-forming composition is a low-temperature solid fuel composition.

### EMBODIMENT OF INVENTION

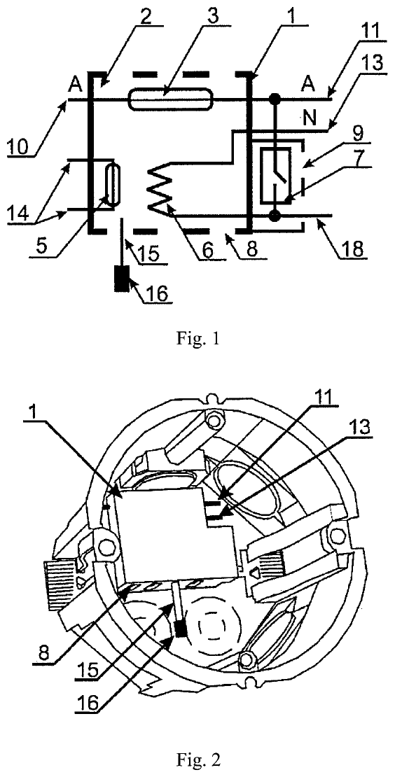

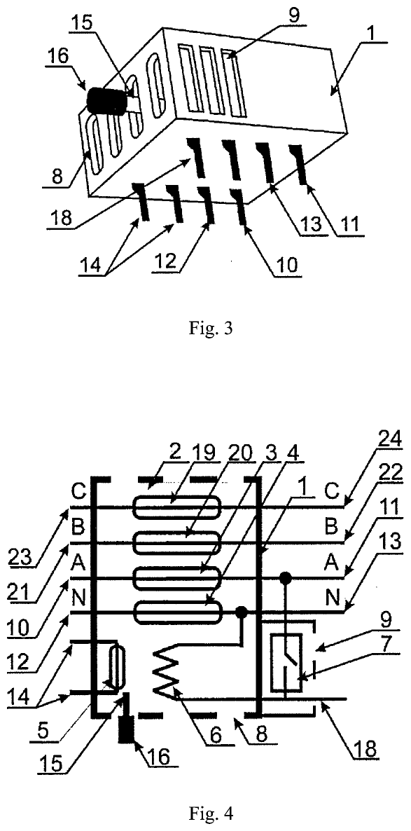

FIG. 1, FIG. 2 and FIG. 3 present the scheme and type of the claimed AFED in a two-line design; in (FIG. 4), the scheme is presented in a four-line design, where 1 is the housing, 2 is the AFC module, 3 is the thermal fuse, 4 is the thermal fuse, 5 is the device triggering sensor, 6 is the AFC electric igniter, 7 is the triggering heat-sensitive device, 8 is the nozzle openings for the exit of an aerosol-forming or gas-forming composition, 9 is the inlet openings for triggering a heat-sensitive device, 10 is an input conductor, for example, of power lines “A”, 11 is an output conductor, for example, of power lines “A”, 12 is an input conductor of the power line “N”, 13 is an output conductor of the power line “N”, 14 is a contact group of conductors of the device's trigger sensor, 15 is a heat-chemical igniter, 16 is a heat-sensitive element, 17 is a housing fasteners, 18 is a conductor for triggering an electric igniter with an external signal, 19 is a thermal fuse, 20 is a thermal fuse, 21 is an input conductor, for example, of power lines “B”, 22 is an output conductor, for example, of power lines “B”, 23 is an input conductor, for example, of power lines “C”, 24 is an output conductor, for example, of power lines “C”.

AFED comprises an aerosol-forming or gas-forming composition (AFC module) (2) and compact housing (1). The AFC module (2) is placed in a housing (1), in which nozzle openings are made for the exit of an aerosol-forming or gas-forming composition (8) and inlet openings (9) for the operation of a triggering heat-sensitive device (7), housing fasteners (17) (may be absent) for attaching the housing (1) to the AFC module (2). The AFED can be placed in the housing of any electrical device, being connected to the input voltage and load through conductors (10, 11, 12, 13) with a two-line design and conductors (10, 11, 12, 13, 21, 22, 23, 24) with a four-line design.

Moreover, it is possible to connect with a two-line design in such a way when the second conductor (12, 13) does not pass the claimed device, and one of the terminals of the electric AFC igniter (6) is connected in the specified line (12, 13) outside the device housing (see FIG. 1)

In this case, it is possible to connect within a two-line design in such a way when the second conductor (12, 13) passes through the claimed device (not shown in the figures), and the second one of the terminals of the AFC electric igniter (6) is connected in the specified line (12, 13) inside the device housing. At the same time, this second line may additionally comprise its own thermal fuse.

The aerosol-forming or gas-forming composition comes from the outlet nozzle (8) of the housing (1) in connection with which additional nozzle openings can be made in the housing (1) for a more uniform supply of the aerosol-forming composition to the protected volume.

The AFC triggering unit is a heat-chemical igniter (15) with a heat-sensitive element (16) and an electric AFC igniter (6).

Preferably, the AFED heat-chemical igniter (15) is made in the form of a housing element and is equipped with a heat-sensitive element (16) located, for example, at the end of the heat-chemical igniter (15), which reduces the self-ignition temperature of the wire, for example, to 170° C. and below. The triggering temperature of the heat-sensitive element (16) is less than the triggering temperature of the heat-chemical igniter (15).

Initially, with a two-line design of the AFED, through the conductors of the power line, for example, “A” (10), and the power line “N” (12), it is connected to an input voltage, for example, 220 V AC or, for example, 12 V DC. The load is connected to the output conductors of the power line “A′” (11) and the conductors of the power line “N′” (13), which in turn are connected to the input conductors via a thermal fuse (3). Electric current flows through the circuit: input of the power line “A” (10)—thermal fuse (3)—output of the power line “A” (11), load, output of the power line “N” (13)—input of the power line “N” (12). Moreover, the power line “N” (12, 13) can both pass through the device according to the claimed invention, and can pass outside the device and only connect to one of the terminals of the electric igniter of the AFC (6).

In the four-line embodiment, electric current additionally flows through the circuit: input of the power line “B” (21)—thermal fuse (19)—output of the power line “B” (22) and input of the power line “C” (23)—thermal fuse (20)—output of the power line “C” (24).

In the four-line embodiment, it is possible to connect the thermal fuse (4) to the input (12) and output (13) conductors of the power line “N”. In this case, the electric current will flow through the circuit: input of the power line “N” (12)—thermal fuse (4)—output of the power line “N” (13).

Thermal fuses are known in the art and their selection is made according to the parameters of the maximum operating current and the maximum operating temperature. For example, the following parameters can be selected: shutdown current of more than −15 A, shutdown temperature of more than −75° C. Thus, the thermal fuse (3) in a two-line design and (3), (4), (19), (20) in the four-line design will open the electrical circuit if any of the parameters are exceeded—exceeding the operating current by a nominal value, for example, 15 A, or heating above a temperature, for example, 75° C.

In the case of voltage supply through conductors (18) and (11) to the AFC electric igniter (6), the AFC module (2) is started allowing remote triggering of the AFED by means of an external signal. Also, when the triggering heat-sensitive element (7) is triggered, when it is heated via the combustion products of the protected device passing through the inlet openings (9) and the triggering of the electric igniter (6) of the AFC, an electrical signal appears briefly on the conductors (until the thermal fuse (3) is opened, which can also start the AFED.

In the event of a fire of the protected device, the AFC electric igniter (6) can additionally be triggered by an external signal through conductors (11) and (13) to which an operating voltage is applied capable of starting the AFC electric igniter (6) through a triggering the heat-sensitive element (7). When the triggering heat-sensitive device (7) is triggered, the voltage is directly applied to the electric igniter (6) of the AFC, which in turn ignites the AFC module (2). At the time of the combustion of the EPA and the release of a fire extinguishing aerosol or fire extinguishing gas, the temperature rises in the housing (1) with a certain delay, for example above 200° C., which simultaneously leads to the opening of the thermal fuse (3), the circuit break along the power line, for example “A”-“A” (10-11) and complete de-energization of the load. Gorenje, as well as the operation of the sensor (5), followed by the output of an information signal to the conductors (14) about the operation of the device in a two-line design. In the four-line embodiment, thermal fuses are additionally opened (4), (19), (20).

In case of loss of the input voltage before the AFED, but the simultaneous development of a fire in the protected device, the AFC module (2) can be additionally triggered using a heat-chemical igniter (15) and a heat-sensitive element (16), which significantly increases the reliability of the device capable of extinguishing fire in the absence of a triggering voltage.

1. An autonomous fire-extinguishing device (AFED) with an aerosol-forming or gas-forming composition placed inside, comprising a housing (1) and an aerosol-forming or gas-forming composition module (2), characterized by the triggering unit which is made in the form of a heat-chemical igniter (15), comprising a heat-sensitive element (16) and an electric igniter (6) of the aerosol-forming or gas-forming composition which is made with the possibility of triggering by an external signal, and also additionally comprising at least one thermal fuse (3) installed in the power wire (11), and one of the contacts of the said thermal fuse (3) is connected to a triggering heat-sensitive device (7), which is connected to an electric igniter (6) of aerosol-forming or a gas-forming composition.

2. An autonomous fire-extinguishing device according to claim 1, characterized by an additional triggering sensor (5) that generates a signal about the operation of an autonomous fire-extinguishing device installed inside the housing (1), with terminals extending beyond the housing (1).

3. An autonomous fire-extinguishing device according to claim 1, characterized by additional holes (8) in the housing (1) for the exit of an aerosol-forming or gas-forming composition, and also contains holes (9) for triggering a heat-sensitive device (7).

4. An autonomous fire-extinguishing device according to claim 1, characterized by a low-temperature solid fuel aerosol-forming or gas-forming composition.

5. An autonomous fire-extinguishing device according to claim 1, characterized by lower triggering temperature of the heat-sensitive element (16) in comparison with the triggering temperature of the heat-chemical igniter (15).
